(19) United States
(12) Patent Application Publication
(10) Pub. No.: US 2026/0022024 A1
(43) Pub. Date: Jan. 22, 2026

(54) METHOD AND SYSTEM FOR EXTRACTING LITHIUM SALT WITH IMPROVED WATER BALANCE

(71) Applicant: Aquatech International, LLC, Canonsburg, PA (US)

(72) Inventors: Jason Alan BOOTSMA, Wichita, KS (US); Constantine Collias, Ontario (CA); Daniel Travis SHAY, Chadds Ford, PA (US); Timothy Jude Campbell, Ridley Park, PA (US); Jonathan David Harker, Wilton (GB)

(73) Assignee: Aquatech International, LLC, Canonsburg, PA (US)

(21) Appl. No.: 19/273,697

(22) Filed: Jul. 18, 2025

Related U.S. Application Data
(60) Provisional application No. 63/674,133, filed on Jul. 22, 2024.

(51) Int. Cl. C01D 15/04; C01D 15/08; C02F 1/42; C02F 1/44; C02F 101/12

(52) U.S. Cl. CPC C01D 15/04; C01D 15/08; C02F 1/42; C02F 1/441; C02F 2101/12; C02F 2301/046

(57) ABSTRACT

A method may use an ion exchange softener system to soften the aqueous lithium-salt containing solution and increase the monovalent:divalent ratio in the solution. A method may pass the softened aqueous lithium-salt containing solution through a lithium adsorbent system to produce a lithium halide stream and a monovalent barren brine stream. A method may flow at least a portion of the barren brine stream to regenerate the ion exchange softener wherein a ratio of monovalent ion to divalent ion in the monovalent barren brine stream is in a range of from about 100:1 to about 1,000,000:1. A method may optionally passing the aqueous lithium-salt containing solution through a second lithium adsorbent system positioned upstream of the ion exchange softener system and the second lithium adsorbent system reduces the hardness of the brine to below 8,000 mg/L hardness as CaCO3 and reduces the TDS to below 40,000 mg/L TDS.

### BACKGROUND

In the field of lithium extraction, the efficient recovery of lithium from aqueous solutions containing various salts presents significant technological challenges. Traditional methods often involve high water and chemical usage, which not only increase operational costs but also raise environmental concerns. The presence of divalent cations in these solutions further complicates the extraction process, necessitating multiple stages of purification to achieve the desired purity of lithium. This background context sets the stage for the development of improved methods and systems that enhance lithium recovery while minimizing resource consumption and environmental impact. The present disclosure seeks to address these challenges by introducing a novel approach that optimizes the extraction process, thereby offering potential benefits over conventional techniques.

### SUMMARY

In some aspects, the techniques described herein relate to a method of extracting a lithium salt such as lithium halide from an aqueous lithium-salt containing solution including monovalent and divalent cations, the method including: using an ion exchange softener system to soften the aqueous lithium-salt containing solution and increase the monovalent:divalent ratio in the solution; passing the softened aqueous lithium-salt containing solution through a lithium adsorbent system to produce a lithium halide stream and a monovalent barren brine stream; flowing at least a portion of the barren brine stream to regenerate the ion exchange softener wherein a ratio of monovalent ion to divalent ion in the monovalent barren brine stream is in a range of from about 100:1 to about 1,000,000:1, and optionally passing the aqueous lithium-salt containing solution through a second lithium adsorbent system positioned upstream of the ion exchange softener system and the second lithium adsorbent system reduces the hardness of the brine to below 8,000 mg/L hardness as CaCO₃ and reduces the TDS to below 40,000 mg/L TDS.

In some aspects, the techniques described herein relate to a lithium extraction system including: an ion exchange softener system adapted to produce a softened aqueous lithium salt-containing solution, a lithium adsorbent system positioned downstream from the softener system and adapted to produce a lithium halide stream and a monovalent barren brine stream, and optionally, a second lithium adsorbent system positioned upstream of the ion exchange softener system.

### BRIEF DESCRIPTION OF THE FIGURES

The drawings illustrate generally, by way of example, but not by way of limitation, various aspects of the present disclosure.

FIG. 1 is a schematic view of a lithium extraction system.

FIG. 2 is a schematic view of another lithium extraction system.

FIG. 3A is a schematic view of another lithium extraction system.

FIG. 3B is a schematic view of another lithium extraction system.

FIG. 4 is a schematic view of another lithium extraction system.

FIG. 5 is a schematic view of a comparative lithium extraction system according to Example 2.

FIG. 6 is a schematic view of a lithium extraction system according to Example 2.

FIG. 7 is a graph showing parameters and results of Example 1.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

As used herein “BWRO” stands for Brackish Water Reverse Osmosis; “DLE” stands for Direct Lithium Extraction; “IX” stands for Ion Exchange; “IXS” stands for Ion Exchange Softening or Ion Exchange System; “LSS” stands for Lithium Selective Sorption; “OARO” stands for Osmotically Assisted Reverse Osmosis; “RO” stands for Reverse Osmosis; “SWRO” stands for Sea Water Reverse Osmosis, and “UHPRO” stands for Ultra High-Pressure Reverse Osmosis

The extraction of lithium from aqueous lithium-salt containing solution sources can be used for battery production but is often hindered by high water usage and inefficient recovery of lithium. Traditional methods involve extensive use of water and chemicals, leading to environmental concerns and high operational costs. Furthermore, the presence of divalent cations in aqueous lithium-salt containing solutions often complicates the extraction process, necessitating multiple purification steps.

The present disclosure relates to methods and systems for extracting lithium from aqueous lithium-salt containing solutions with improved water efficiency and reduced chemical usage. Typically, the targeted lithium-salt containing solution includes a lithium halide such as lithium chloride and possibly lithium bromide. However, lithium carbonate or lithium sulphate are not within this scope of this disclosure. Importantly, the disclosure includes softening aqueous lithium-salt containing solutions to remove divalent cations before lithium extraction, using a lithium adsorbent system, and regenerating this system using barren brine. This approach not only enhances lithium recovery but also significantly reduces water and chemical consumption by recycling process streams.

The source of the aqueous lithium salt-containing solution is not limited by the disclosure but may originate from a variety of sources such as any of a geothermal source, oil fields, hard rock lithium mining, mineral digestion, tailings from a lithium mining process, a well application, a clay or sea water. In another example, the aqueous lithium salt-containing solution is produced synthetically by extraction from a lithium containing material and may be, for example, any aqueous recycling solution containing lithium halide. Examples of lithium containing materials include spodumene, lepidolite, hectorite clays, black mass, off-specification battery materials, recycled battery materials or combinations of these materials; the resulting extractant in these examples comprises acidity and cations. Examples of components of the extractant are hydrochloric acid, sodium chloride, potassium chloride, perchloric acid and chloric acid. The extractant is then pH adjusted to the desired range for a specific sorbent. The aqueous lithium salt-containing solution may therefore be a naturally-occurring solution or a synthetic solution, or a combination thereof. The lithium may be considered to be a brine and may be present in the aqueous lithium-containing solution as, for example, lithium halide.

In some examples, the oxidative-reductive potential, and/or pH of the aqueous lithium salt-containing solution can be adjusted so as to be higher or lower than the original oxidative-reductive potential, and/or pH. The oxidative-reductive potential, and/or pH, can be increased by air sparging, addition of an oxidant or an electro-chemical modification. The oxidant may be any substance capable of increasing the ORP of a solution, and may be, for example, any of hydrogen peroxide, ozone, sodium hypochlorite, potassium monopersulfate, hypochlorous acid, a hydroxy radical or any other suitable compound capable of increasing oxidative-reductive potential. The oxidative-reductive potential, and/or pH, can be decreased by adding formic acid, metal hydride, or any other suitable compound capable of decreasing oxidative-reductive potential.

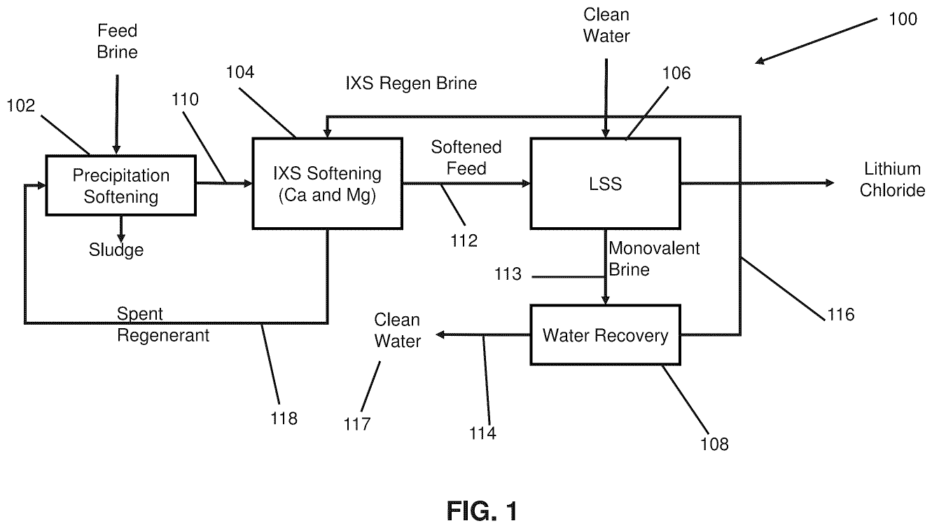

An example of a lithium extraction system is shown schematically in FIG. 1. As shown in FIG. 1, system 100 includes precipitation softening system 102, ion-exchange softening (IXS) system 104, lithium adsorbent (LSS) system 106, and water recovery system 108. The aqueous lithium-salt containing solution (feed brine) can be prepared for lithium extraction by subjecting it to pH adjustment, filtration, ORP adjustment, temperature adjustment, nanofiltration (which can act as a softening step by separating divalent ions from monovalent ions) or a combination thereof.

Precipitation softening system 102 is upstream of ion-exchange softening system 104 in flow communication with each other by conduit 110. Lithium adsorbent system 106 is downstream of ion-exchange softening system 104 and in flow communication with ion-exchange softening system 104 by conduit 112. Water recovery system 108 is downstream of lithium adsorbent system 106 and in flow communication with lithium adsorbent system 106 by conduit 113. Water, such as clean water 117, may output the water recovery system 108 by conduit 114. Lithium adsorbent system 104 can reduce the hardness in the aqueous lithium-salt containing solution to below 8,000 mg/L hardness as CaCO₃ and reduce the monovalent cations concentration below 40,000 mg/L monovalent cations concentration. As used herein a lithium adsorbent system can include any known lithium adsorbent, for example, ion sieve adsorbent, a lithium metal oxide adsorbent, a mixed metal oxide adsorbent, an alkali or alkali earth metal/alumina matrix, transition metal/alumina matrix or a molecular sieve adsorbent.

In operation, a lithium-salt containing solution is fed to precipitation softening system 102. In general, a precipitation softening system is a water treatment process designed to remove hardness-causing minerals from water, primarily, but not limited to, calcium and magnesium, which are typically present as bicarbonates, sulfates, and chlorides. The process involves the addition of chemicals to the water that cause these minerals to form solid precipitates, which can then be removed through sedimentation, filtration, or flotation. This method is often used in industrial settings, including for the treatment of boiler stream water and in large-scale water purification facilities. Precipitation softening system 102 may not remove all hardness-causing materials and need not be included in all examples of the instantly disclosed system. The softened aqueous lithium-salt containing solution flows via conduit 110 to ion-exchange softening system 104.

Ion exchange softening involves passing an aqueous lithium-salt containing solution through a column filled with ion exchange resin. These resins are typically composed of sodium (Na) charged beads. As the aqueous lithium-salt containing solution passes through the resin, the calcium and magnesium ions in the aqueous lithium-salt containing solution are exchanged with sodium ions from the resin. This exchange removes divalent hardness ions from the aqueous lithium-salt containing solution, replacing them with monovalent sodium ions, which do not contribute to hardness. In operation, the aqueous lithium-salt containing solution is first collected and may undergo preliminary filtration or softening such as precipitation softening system 102 to remove any large particulates or debris that could interfere with the ion exchange process. A strong acid cation exchange resin is typically used, which is effective at operating across a broad range of pH levels and has a high capacity for divalent cations.

As an example, the aqueous lithium-salt containing solution can be passed through one or more columns filled with the ion exchange resin. The resin beads exchange their sodium ions for the calcium and magnesium ions in the aqueous lithium-salt containing solution. This process continues until the resin reaches its capacity and can no longer effectively exchange ions. Once the resin is saturated with calcium and magnesium, it must be regenerated to restore its sodium ion content. Regeneration involves flushing the resin with a high concentration of a sodium chloride (salt) solution. The high concentration of sodium ions displaces the calcium and magnesium ions, which are then washed out of the column. The resin is then rinsed to remove excess salt before being put back into service. The resin (spent reagent) can also be routed to precipitation softening system 102 by conduit 118. The softened aqueous lithium-salt containing solution (softened feed), now predominantly containing sodium and lithium ions, is collected from the ion exchange system and passed to lithium adsorbent system 106 by conduit 112.

Lithium adsorbent system (LSS) is a specialized process used in the extraction of lithium from aqueous lithium-salt containing solutions, which are typically found in natural sources like salt lakes or underground reservoirs. The lithium adsorbent system is designed to selectively remove lithium ions from these aqueous lithium-salt containing solution, which also contain various other dissolved salts and minerals. The core of a lithium adsorbent system is its adsorption media, which is specifically engineered to preferentially bind lithium ions over other ions present in the aqueous lithium-salt containing solution. Commonly used materials include lithium aluminum layered double hydroxides, ion exchange resins, or other specialized lithium-selective sorbents. These materials have specific chemical or physical properties that allow them to selectively interact with lithium ions, often through mechanisms like ion exchange, chelation, or surface adsorption.

The prepared aqueous lithium-salt containing solution is passed through a series of columns or tanks filled with the adsorption media. This can be done in batch mode or continuous flow, depending on the design of the system. As the aqueous lithium-salt containing solution flows through the media, lithium ions are selectively adsorbed onto the media, while most other ions pass through.

Once the adsorption media is saturated with lithium, the lithium must be recovered from the media to regenerate its adsorption capacity and to collect the extracted lithium. This is typically achieved by flushing the media with a desorption solution, which can vary based on the type of adsorbent used but often involves changes in pH, the introduction of a competing ion, or the use of a complexing agent that has a higher affinity for the adsorbent than lithium. The desorption process releases lithium ions into the solution, from which lithium can be further concentrated and purified through additional processes like precipitation, crystallization, or further ion exchange. The lithium can also be subjected to carbonization. A ratio of monovalent ion to divalent ion of the lithium adsorbent system product (monovalent brine) ranges from about 100:1 to about 1.000,000:1, about 10,000:1 to about 1,000,000:1, or about 15,000:1 to about 1,000,000:1 This ratio is important for lithium loading on a column of the lithium adsorbent system.

Indeed, it was unexpectedly found that increasing the ratio of monovalent:divalent ions increases lithium loading on the subsequent column. While it is expected that there is a minimal amount of total dissolved solids (e.g., monovalent ions) required for lithium to load on the media, this has been found to be only partially true. There must be a minimum amount of monovalent cations in the aqueous lithium-salt containing solution to allow for adequate lithium sorption. Without intending to be bound to any theory, the reason for this is thought to be due to the hydration enthalpy and charge balance of NaCl vs CaCl₂). In examining Li loading curves at different molar levels of either Ca or Na, one skilled in the art would expect the Na curves with the increasing Li loading capacity as the Na concentration increases. However, this is not true for divalent ions. It is actually the decrease in Ca that enhances the Li loading. It's not just total dissolved solids, but the type of total dissolved solid that has an effect. Additionally, when the ratio of divalent to monovalent approaches 1, Li never fully loads in its entirety on the media.

After desorption, the adsorption media can be regenerated for reuse in the lithium adsorbent system. This may involve washing the media with specific solutions to remove any residual impurities and restore its lithium-selective properties.

The resulting products from lithium adsorbent system include lithium halide and a monovalent aqueous lithium-salt containing solution. The lithium halide can be collected for use or subjected to further processing. The monovalent aqueous lithium-salt containing solution (monovalent brine) can be processed through water recovery system 108. In some embodiments, water recovery system 108 may facilitate osmosis to output water with reduced concentrations of unwanted molecules, species, or precipitates. In some embodiments, water recovery system 108 may be configured to facilitate brackish water reverse osmosis, seawater reverse osmosis, ultra-high pressure reverse osmosis, osmotically assisted reverse osmosis, or evaporation, or a combination thereof. Reverse osmosis (RO) is a water purification technology that utilizes a semi-permeable membrane to remove ions, unwanted molecules, and larger particles from water, such as drinking water. In reverse osmosis, pressure is applied to overcome osmotic pressure, a colligative property that is driven by chemical potential differences of the solvent, a thermodynamic parameter. This process can remove many types of dissolved and suspended chemical species as well as biological ones (primarily bacteria) from water and is used in both industrial processes and the production of potable water.

Brackish water reverse osmosis systems deal with water sources that have lower salt concentrations than seawater but are still too salty for most practical purposes. These systems require less pressure than SWRO systems, making them less energy-intensive. Brackish water RO is often used for purifying water from rivers or lakes that have a higher salt content, which can be common in estuarine areas or regions with significant groundwater intrusion.

Seawater reverse osmosis (SWRO) systems are designed to handle the high salt concentration in water. They typically operate under higher pressure than freshwater systems, which is necessary to overcome the strong osmotic pressure of seawater. This technology is crucial for desalinating seawater to produce fresh water suitable for human consumption or irrigation. The membranes used in SWRO are generally more robust and resistant to the corrosive nature of seawater.

Ultra-high pressure reverse osmosis systems are used when very high rejection rates of solutes are needed or when the stream water is extremely saline and traditional RO pressures are insufficient to achieve the desired level of desalination. These systems operate at pressures significantly higher than conventional RO systems, which increases the efficiency of the salt rejection process but also requires more robust system components capable of handling the increased pressure.

Osmotically assisted reverse osmosis is a variation of traditional RO that is designed to treat very high-salinity waters, such as those produced in some industrial processes or in water softening applications. This method uses an osmotic agent on the concentrate side of the membrane to help reduce the osmotic pressure difference across the membrane. This reduction in osmotic pressure allows the system to operate at lower hydraulic pressures, reducing energy costs and stress on the membranes.

An output of water recovery system 108 is clean (e.g., low monovalent cations concentration) water 117. Clean water 117 can be reused in other parts of system 100 such as lithium adsorbent system 106. In some embodiments, the solids from water recovery system 108 can be routed to ion-exchange softening system 104 via conduit 116. Recirculating clean water by-product from an osmosis procedure to a lithium adsorbent system, as an example, results in about 90% to about 99%, about 90% to about 98%, or about 95% to about 97% less water usage than a corresponding method that is free of recirculating water or recirculates less water.

In locations where water is scarce, it may be necessary to evaporate even high total dissolved solid waste streams such as divalent containing barren brine and spent softener regeneration solution. These streams are too high in high total dissolved solid for membrane systems to be effective for recovering water as even the most advanced membrane systems are limited to processing streams below 200,000 mg/L high total dissolved solid. Examples of processes that can be used to recover water from high total dissolved solid streams are evaporators and humidification-dehumidification technologies. Evaporators are varied in their configuration, but those used for water recovery include an evaporation chamber, an energy source, and a condenser. Examples of evaporation chambers include plate exchangers, shell and tube exchangers, and jacketed vessels. Examples of energy sources include vacuum pumps, boilers, burners, and compressors. Examples of condensers include exchangers and direct contact condensers. An example evaporator system is a mechanical vapor recompression (MVR) which uses a compressor to provide the energy of evaporation and is one of the most efficient evaporation systems available today. Humidification-dehumidification systems contain some similar components to evaporation systems, but have the distinction of not increasing the temperature or reducing the pressure to provide the heat of evaporation. These systems have the advantage of lower energy inputs and lower fouling rates compared to evaporators. These systems require effective mass transfer as they rely on the manipulation of the humidity of air or another gas stream that is forced through the liquid. The liquid saturates the air stream which increases the high total dissolved solid of the remaining liquid. The air stream is taken to another vessel to be dehumidified which recovers the water that had been liberated from the high total dissolved solid stream.

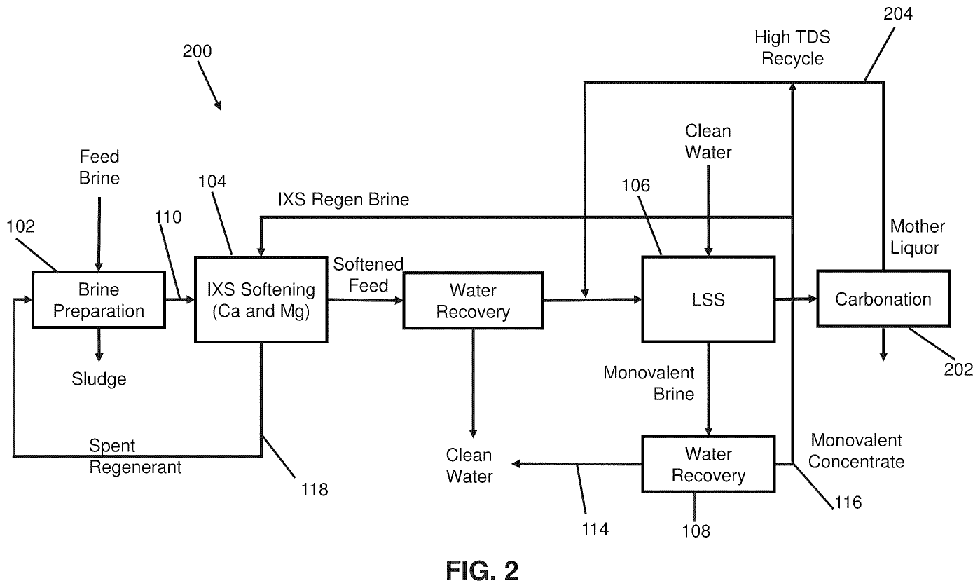

System 100 can be further developed. For example, as shown in FIG. 2, system 200 can include components to enhance the total monovalent cation concentration content. FIGS. 1-4 show many of the same components and use common reference numbers.

Ensuring that the softened stream to the lithium adsorbent system is sufficiently high in monovalent cation concentration to enable lithium loading onto the media is important. The monovalent cation concentration level needed can be achieved by augmenting the monovalent cation concentration by adding low-hardness solutions. The eluate from the lithium adsorbent system will typically be too low in monovalent cation concentration for effective loading unto a secondary lithium adsorbent system and will require augmentation of the monovalent cation concentration. It is important to select a suitable source for monovalent cation concentration augmentation to prevent the introduction of contaminants into the softened process stream. Avoiding the reintroduction of divalent cations which have been substantially reduced with the previous ion exchange softening step can be particularly important. As an example, there are three sources of low-hardness monovalent cation concentration that can be effective in monovalent cation concentration augmentation of a secondary lithium adsorbent system stream.

System 200 includes carbonation via carbonizer 202. Carbonizer 202 facilities carbonization of lithium to make lithium halide. Another product from carbonizer 202 is a mother liquor. This mother liquor contains lithium halide which was unreacted in the carbonization process in addition to a significant amount of sodium chloride which was generated in the reaction between sodium carbonate and lithium halide. The stream to the carbonization process is of low-hardness and results in a mother liquor that is a low-hardness source of monovalent cation concentration containing lithium. A secondary benefit to the use of this stream is that it recovers the unreacted lithium halide that requires processing to capture. The mother liquor can be provided to lithium adsorbent system 106 by conduit 204. Solids can also come from water recovery system 108 or the barren brine from lithium adsorbent system 106.

Using any of the aforementioned methods to boost the monovalent cations concentration content can also be helpful to maximize the yield of lithium. For example, if the stream fed into lithium adsorbent system 106 has a high lithium content, it may suffer from poor recoveries as the adsorption capacity of the media can be quickly overwhelmed. The result is very short loading cycles which contribute to increased water usage. Therefore, it may be advantageous to do monovalent cation concentration augmentation of a secondary lithium adsorbent system stream.

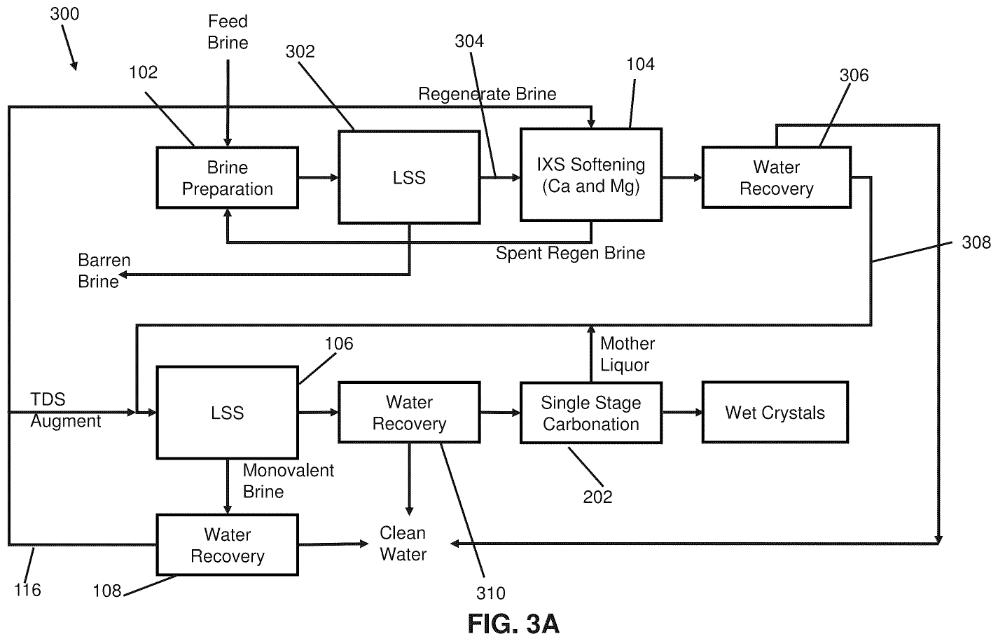

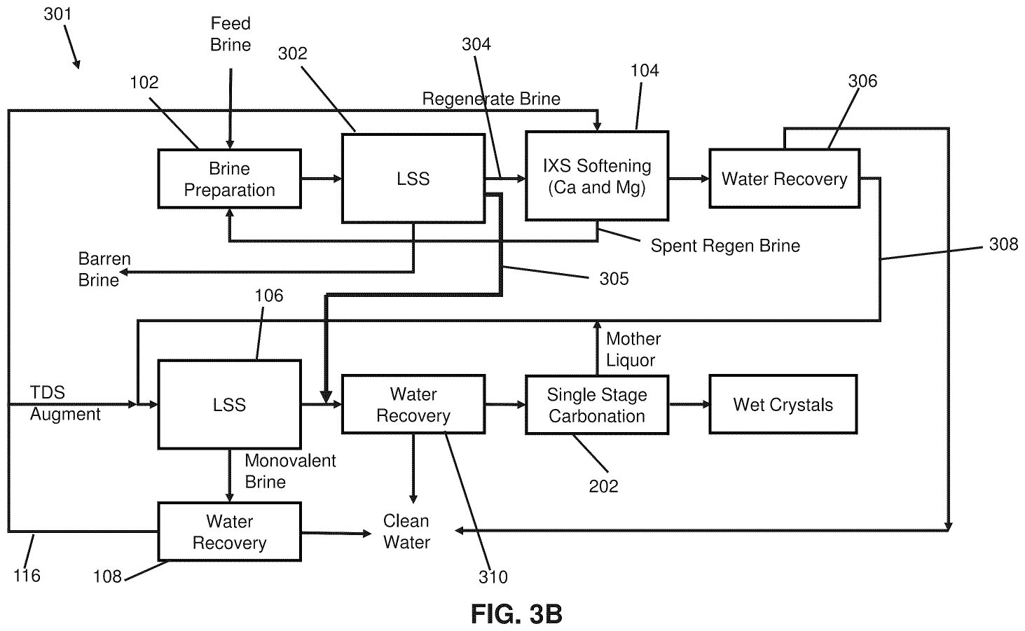

As shown in FIG. 3A, in some embodiments, system 300 can include a second lithium adsorbent system (LSS) 302. FIG. 3A includes many of the same components as FIGS. 1 and 2 and common reference numbers are used. Lithium adsorbent system 302 is positioned upstream of ion-exchange softening system 104 and connected thereto by conduit 304. In operation, using selective sorption system 302 produces a rough lithium eluate cut that has high enough monovalent cations concentration that the eluate can ultimately be loaded onto lithium adsorbent system 106 that achieves the highest grams of lithium adsorbed per hour. Eluate from ion-exchange softening system 104 is concentrated using water recovery system 306. Eluate from water recovery system 306 is fed to lithium adsorbent system 106 by conduit 308.

Monovalent lithium product from lithium adsorbent system 106 can be sent to water recovery system 108 where it can be regenerated for use in ion-exchange softening system 104 and to produce clean water to use in system 300. Monovalent aqueous lithium-salt containing solution can also be sent to water recovery system 310 where the eluent can be sent to carbonator 202 and a mother liquor can be recovered for total dissolved solid augmentation. Eluate can also be produced when system 302 is aligned to feed brine to displace the vessel contents where its composition also falls within the above criteria. Eluate can be produced when system 302 is aligned to feed brine to displace the vessel contents where its composition is suitable for product specification.

As shown in FIG. 3B, in some embodiments, system 301 can include a bypass stream 305 from lithium adsorbent system 302 directly to the product eluate stream downstream of lithium adsorbent system 106. FIG. 3B includes many of the same components as in FIGS. 1, 2, and 3A and common reference numbers are used. As shown in FIG. 3B, lithium adsorbent system 302 is positioned upstream of ion-exchange softening system 104 and connected thereto by conduit 304. In operation, lithium adsorbent system 302 may produce two separate eluate streams where a first eluate stream has a low lithium purity and the second eluate stream has a high lithium purity. The low lithium purity eluate stream may output from lithium adsorbent system 302 by conduit 304 and be processed as described above. The high lithium purity eluate stream may be output from lithium adsorbent system 302 by conduit 305. The high lithium purity eluate stream takes a portion of the primary eluate stream (e.g., to be output from conduit 304) containing a desirably high lithium purity (e.g., a high Li:TDS ratio). It is appreciated that conduit 305 may be referred to interchangeably as eluate bypass stream 305. Lithium adsorbent system 302 may then send the eluate bypass stream 305 directly to the product eluate stream downstream of lithium adsorbent system 106. In some embodiments, the eluate bypass stream 305 may be combined with the product eluate stream of lithium adsorbent system 106. Lithium adsorbent system 302 may select higher purity lithium that does not require further processing by lithium adsorbent system 106 and segregate from lower purity lithium.

As used herein, the term “low lithium purity” means a Li:TDS ratio of less than 0.08, for example, less than about 0.06 or less than about 0.04. “Li:TDS ratio” refers to a mg/mL of lithium in proportion to a mg/mL of total dissolved solids (TDS). As used herein, the term “high lithium purity” means a Li:TDS ratio of greater than 0.08, for example, greater than about 0.10, greater than about 0.11, greater than about 0.115, greater than about 0.12, greater than about 0.125, greater than about 0.13, greater than about 0.135, or greater than about 0.14. In some embodiments, “high lithium purity” means a Li:TDS ratio greater than about 0.13.

In some embodiments, the bypass eluate stream 305 may be combined with the product eluate stream of lithium adsorbent system 106, and may further be concentrated and refined together (e.g., for example with the water recovery and carbonation equipment shown in FIG. 3B).

In some embodiments, the eluate bypass stream 305 may be concentrated and refined independently of the product eluate stream of lithium adsorbent system 106 (e.g., in separate processing equipment, for example separate water recovery and separate carbonation equipment not shown in FIG. 3B).

Several benefits are provided by use of two lithium adsorbent systems including a high lithium purity eluate bypass according to embodiments disclosed herein. Without being bound by theory, it is believed that, in a process with only a single lithium adsorbent system, an excess of unwanted marginal Li:TDS voids remain in the monovalent lithium product output from the single lithium adsorbent system. This may require a high level of recycle back to the brine feed tank in order to re-process and reduce those voids. In processes with two lithium adsorbent systems, the excess marginal Li:TDS voids in the low lithium purity monovalent lithium output from the first lithium adsorbent system are processed in the second lithium adsorbent system to produce a monovalent lithium product output from the second lithium adsorbent system with lower or acceptable Li:TDS voids. In this way, the total number of unwanted marginal Li:TDS voids generated in the overall process are reduced and the volume of voids that may need to be recycled back to the brine feed tank is reduced. In addition, by using an eluate bypass output stream, the high lithium purity monovalent lithium product from the first lithium adsorbent system, which would benefit relatively less from a second lithium adsorbent system, can bypass that second lithium adsorbent system altogether. This has the added benefit of enabling use of smaller process equipment for the second lithium adsorbent system, auxiliary equipment, and/or downstream processing equipment (e.g., water recovery and carbonation equipment) compared to what would be needed to process the whole eluate stream from the first lithium adsorbent system without a second lithium adsorbent system and/or without a bypass. This reduced size of equipment beneficially reduces the cost of installation and operation, as well as improves the overall water balance by reducing the total process water usage.

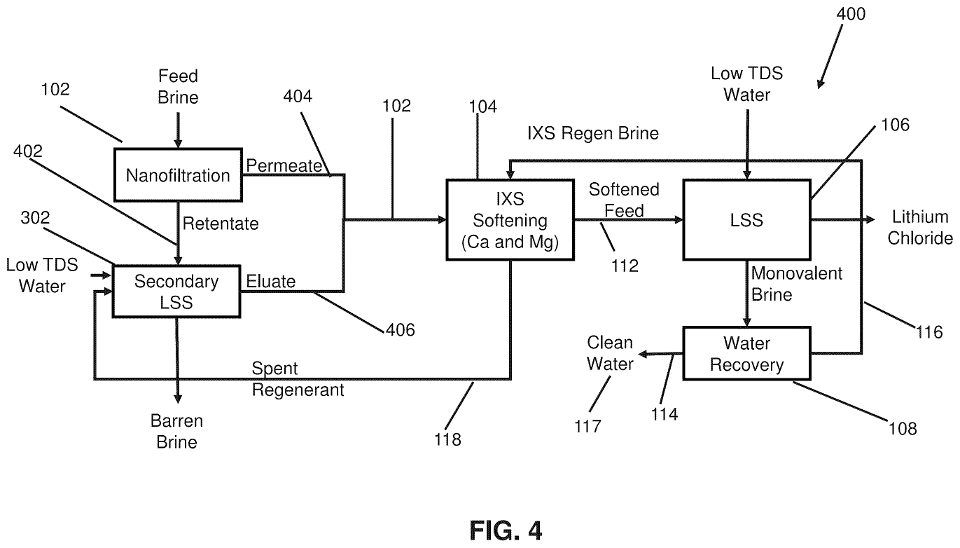

As shown in FIG. 4, the lithium halide salt can be subjected to nanofiltration as an initial step. Nanofiltration membranes are greater than 90% selective for the rejection of calcium and magnesium cations while allowing monovalent ions like sodium, potassium, and lithium to pass through. This technology can be useful as a brine preparation step before ion exchange softening because it reduces the divalent cations to an acceptable level while allowing the monovalent cations. Other membrane technologies used for the softening of water like reverse osmosis will remove all ions including lithium and other monovalent ions and therefore cannot be used in a lithium recovery system. Nanofiltration has the advantage over other chemical or ion exchange systems of not requiring any water or chemical additions to operate. Nanofiltration only requires electricity and is more energy efficient than reverse osmosis since it operates at much lower pressure.

Nanofiltration softening results in a relatively large reject stream 402, which can be anywhere from 5% up to 85% of the original feed volume. This reject volume contains a similar concentration of lithium as the original brine feed and that high product loss would be costly and wasteful. A solution to reject stream 402 is to process it with secondary lithium adsorption system 302 to separate the high levels of hardness in that stream. Eluate 406 from secondary lithium adsorption system 302 is then blended with nanofiltration permeate 404 and processed with ion exchange softening system 104 to remove substantially all hardness from the feed to the first lithium adsorption system. The advantage of processing the brine in this way is that secondary lithium adsorption system 302 can be smaller than if all of the brine was prepared directly with it. This configuration saves on capital costs and improves the water balance since the volume of water rejected in the barren brine of the secondary lithium adsorption system is much smaller.

### Examples

The following Example is intended to illustrate an aspect of the disclosure, the disclosure is not limited by this section.

### Example 1

A transparent PVC column, 4 feet in height and 1 inch in diameter, was filled with 500 mL of sorption resin. The column was subjected to a brine solution flowing downward at 132 cc/min. The brine composition included 4% Na (sodium chloride), 1.2% Ca (calcium chloride), 800 ppm Mg (magnesium chloride), and 250 ppm Li (lithium halide).

The sorption resin was exposed to the brine solution continuously for 20 bed volumes (10,000 mL). Subsequently, clean deionized water was passed through the resin column at the same flow rate for another 20 bed volumes, completing one cycle. This loading and elution sequence was repeated twice more to condition the sorption resin and bring it to steady state.

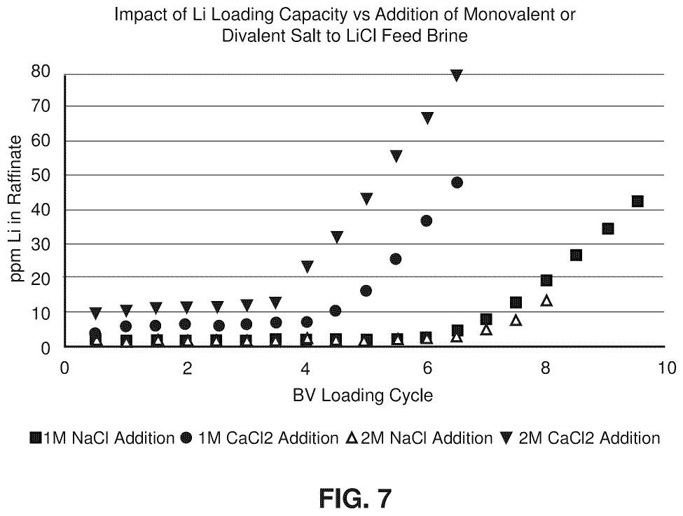

After conditioning, brines of various molar concentrations of monovalent NaCl and divalent CaCl₂) with 250 ppm Li were prepared according to the Table 1. Results are shown graphically in FIG. 7. Each brine was loaded on the freshly eluted and conditioned column as described above and samples of the raffinate were analyzed by ICP-OES measuring the Li concentration to determine sorption media Li loading efficiency. It is understood that 0 ppm Li detected in the raffinate indicates 100% of the Li in the feed brine was adsorbed on the sorption media and an increase in Li detected in the raffinate indicated a decrease in Li loading capacity.

TABLE 1

| 1M NaCl Addition | | 1M CaCl₂ Addition | | 2M NaCl Addition | | 2M CaCl₂ Addition | |
|---|---|---|---|---|---|---|---|
| BV | ppm Li in | BV | ppm Li in | BV | ppm Li in | BV | ppm Li in |
| Loading | Raffinate | Loading | Raffinate | Loading | Raffinate | Loading | Raffinate |
| 0.5 | 2 | 0.5 | 54 | 0.5 | 47 | 0.5 | 25 |
| 1 | 2 | 1 | 51 | 1 | 46 | 1 | 9 |
| 1.5 | 2 | 1.5 | 46 | 1.5 | 44 | 1.5 | 11 |
| 2 | 2 | 2 | 45 | 2 | 2 | 2 | 12 |
| 2.5 | 2 | 2.5 | 4 | 2.5 | 1 | 2.5 | 12 |
| 3 | 2 | 3 | 6 | 3 | 1 | 3 | 12 |
| 3.5 | 2 | 3.5 | 6 | 3.5 | 1 | 3.5 | 12 |
| 4 | 2 | 4 | 6 | 4 | 1 | 4 | 13 |
| 4.5 | 2 | 4.5 | 7 | 4.5 | 1 | 4.5 | 23 |
| 5 | 2 | 5 | 7 | 5 | 1 | 5 | 33 |
| 5.5 | 2 | 5.5 | 7 | 5.5 | 1 | 5.5 | 44 |
| 6 | 3 | 6 | 7 | 6 | 1 | 6 | 56 |
| 6.5 | 5 | 6.5 | 10 | 6.5 | 1 | 6.5 | 68 |
| 7 | 8 | 7 | 17 | 7 | 1 | 7 | 79 |
| 7.5 | 13 | 7.5 | 26 | 7.5 | 2 | | |
| 8 | 19 | 8 | 37 | 8 | 2 | | |
| 8.5 | 26 | 8.5 | 49 | 8.5 | 4 | | |
| 9 | 34 | | | 9 | 8 | | |
| 9.5 | 43 | | | 9.5 | 14 | | |

### Example 2

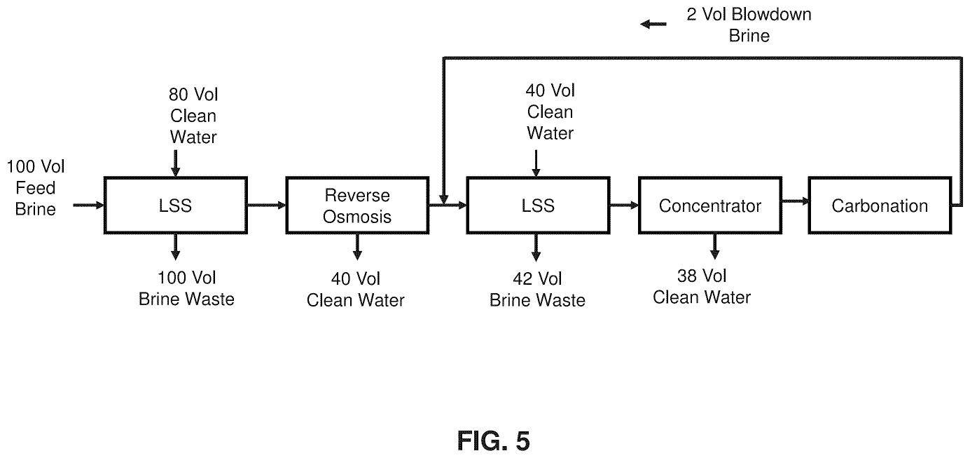

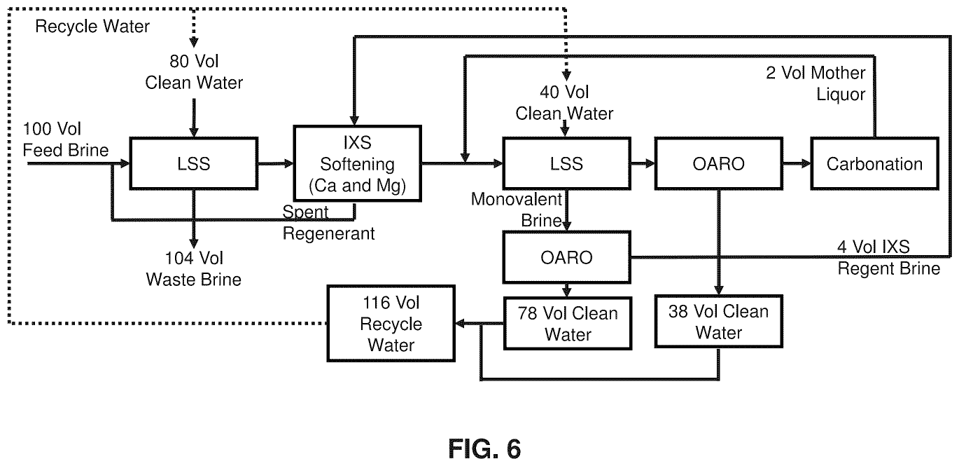

FIG. 5 is a schematic view of a comparative lithium extraction system and FIG. 6 is a schematic view of a lithium extraction system within the scope of this disclosure. In each system a lithium containing brine is added and the output of clean (e.g., low total dissolved solids) water is measured. Clean water can be reused in the system. Table 2 shows the clean water output of the comparative system and Table 3 shows the clear water output of the system within the scope of this disclosure. As shown the instant system results in 90% less water usage than the comparative system.

TABLE 2

| Stream | Input | Output | Net Volume | Percentages |
|---|---|---|---|---|
| Brine | 100 | 104 | 4 Volume | 4% over |
| | Volumes | Volumes | increase | volume |
| Clean | 120 | 116 | 4 Volume usage | 4% vol/vol |
| Water | Volumes | Volumes | | usage |

TABLE 3

| Stream | Input | Output | Net Volume | Percentages |
|---|---|---|---|---|
| Brine | 100 | 104 | 4 Volume | 4% over |
| | Volumes | Volumes | increase | volume |
| Clean | 120 | 116 | 4 Volume usage | 4% vol/vol |
| Water | Volumes | Volumes | | usage |

### Exemplary Clauses

The following exemplary clauses are provided, the numbering of which is not to be construed as designating levels of importance:

Clause 1. A method of extracting lithium halide from an aqueous lithium-salt containing solution comprising monovalent and divalent cations, the method comprising: using an ion exchange softener system to soften the aqueous lithium-salt containing solution and increase a monovalent:divalent ratio in the solution; passing the softened aqueous lithium-salt containing solution through a lithium adsorbent system to produce a lithium halide stream and a monovalent barren brine stream; flowing at least a portion of the barren brine stream to regenerate the ion exchange softener; wherein a ratio of monovalent ion to divalent ion in a monovalent dominant barren brine stream is in a range of from about 100:1 to about 1,000,000:1, and optionally passing the aqueous lithium-salt containing solution through a second lithium adsorbent system positioned upstream of the ion exchange softener system and the second lithium adsorbent system reduces a hardness of the brine to below 8,000 mg/L hardness as CaCO3 and reduces a total dissolved solids (TDS) concentration TDS to below 40,000 mg/L TDS.

Clause 2. The method of clause 1, wherein the lithium adsorbent system is a first lithium adsorbent system and the method further comprises passing the aqueous lithium-salt containing solution through the second lithium adsorbent system upstream of the first lithium adsorbent system.

Clause 3. The method of clause 2, wherein the second lithium adsorbent system positioned upstream of the ion exchange softener system splits the aqueous lithium-salt containing solution into a low lithium purity stream and a high lithium purity stream, wherein the low lithium purity stream is provided to the ion exchange softener system and has a ratio of lithium to TDS (Li:TDS) that is lower than the high lithium purity stream.

Clause 4. The method of clause 3, wherein the high lithium purity stream is combined with the lithium halide stream produced by the first lithium adsorbent stream.

Clause 5. The method of any one of clauses 2-4, wherein the high lithium purity stream has a ratio of lithium to TDS (Li:TDS) that is greater than 0.08, for example greater than about 0.10, greater than about 0.11, greater than about 0.115, greater than about 0.12, greater than about 0.125, greater than about 0.13, greater than about 0.135, or greater than about 0.14, and wherein the low lithium purity stream has a ratio of lithium to TDS (Li:TDS) that is less than 0.08, for example, less than about 0.06 or less than about 0.04.

Clause 6. The method of clause 1, further comprising preparing the aqueous lithium-salt containing solution before ion exchange softening, wherein preparing the brine comprises mechanical pretreatment, chemical pretreatment, nanofiltration, or pH adjustment, filtration, temperatures adjustment or oxidative reduction potential adjustment.

Clause 7. The method of lithium adsorbent system of any of clauses 1 to 6, wherein the lithium halide stream comprises lithium chloride.

Clause 8. The method of any of clauses 1-7, further comprising passing the barren brine stream through a water recovery system prior to flowing the barren brine stream to the softener.

Clause 9. The method of clause 8, wherein the water recovery system uses brackish water reverse osmosis, seawater reverse osmosis, ultra-high pressure reverse osmosis, osmotically assisted reverse osmosis, evaporation, or a combination thereof.

Clause 10. The method of any of clauses 1-9, further comprising concentrating the lithium halide stream.

Clause 11. The method of clause 10, wherein concentrating the lithium halide stream is accomplished using a water recovery system.

Clause 12. The method of clause 11, wherein the water recovery system uses brackish water reverse osmosis, seawater reverse osmosis, ultra-high pressure reverse osmosis, osmotically assisted reverse osmosis, evaporation, or a combination thereof.

Clause 13. The method of any of clauses 11 or 12, further comprising subjecting the concentrated lithium halide stream to carbonization to form lithium carbonate.

Clause 14. The method of clause 13, wherein carbonization is performed with sodium carbonate or caustic/carbon dioxide insufflation.

Clause 15. The method of any of clauses 13 or 14, further comprising converting lithium carbonate to lithium hydroxide with calcium hydroxide or sodium hydroxide.

Clause 16. The method of any one of clauses 1-15, further comprising augmenting a monovalent cations concentration of the softened aqueous lithium-salt containing solution.

Clause 17. The method of clause 16, wherein augmenting the monovalent cations concentration of the softened aqueous lithium-salt containing solution comprises contacting the softened aqueous lithium-salt containing solution with a stream of mother liquor from carbonization.

Clause 18. The method of any of clauses 16 or 17, wherein augmenting the monovalent cations concentration of the softened aqueous lithium-salt containing solution comprises contacting the softened aqueous lithium-salt containing solution with a concentrated solution of the barren brine.

Clause 19. The method of any of clauses 1-18, wherein the barren brine is concentrated using reverse osmosis.

Clause 20. The method of clause 19, wherein the reverse osmosis uses brackish water reverse osmosis, seawater reverse osmosis, ultra-high pressure reverse osmosis, osmotically assisted reverse osmosis, evaporation, or a combination thereof.

Clause 21. The method of any of clauses 18-20, wherein augmenting the monovalent cations concentration of the softened aqueous lithium-salt containing solution comprises contacting the softened aqueous lithium-salt containing solution with a monovalent halide salt recovered from the barren brine.

Clause 22. The method of any of clauses 1-21, further comprising recirculating clean water by-product from an osmosis procedure to a lithium adsorbent system.

Clause 23. The method of clause 22, wherein recirculating water results in about 60% to about 99% less water usage than a corresponding method that is free of recirculating water or recirculates less water.

Clause 24. The method of any of clauses 22 or 23, wherein recirculating water results in about 90% to about 98% less water usage than a corresponding method that is free of recirculating water or recirculates less water.

Clause 25. The method of any one of clauses 1-24, wherein a monovalent ion content of the lithium halide stream from the lithium adsorbent system is higher than the monovalent ion content of the lithium halide stream from the second lithium adsorbent system.

Clause 26. The method of any one of clauses 1-25, further comprising augmenting a softened first lithium-containing eluate with monovalent cations (low hardness TDS) before introduction to the lithium adsorbent system.

Clause 27. The method of clause 26, wherein augmenting a softened first lithium-containing eluate with monovalent cations (low hardness TDS) before introduction to a direct lithium extraction in the lithium adsorbent system comprises adding at least a portion of a mother liquor from carbonating the lithium-containing eluate to the softened first lithium-containing eluate.

Clause 28. The method of clause 26, wherein augmenting a softened first lithium-containing eluate with monovalent cations (low hardness TDS) before introduction to a direct lithium extraction in the lithium adsorbent system comprises concentrating a second barren brine with reverse osmosis and adding said concentrated second barren brine to the softened first lithium-containing eluate.

Clause 29. The method of clause 26, wherein augmenting the softened first lithium-containing eluate with monovalent cations (low hardness TDS) before introduction to a direct lithium extraction in the lithium adsorbent system comprises adding a solution of monovalent halide salts to the softened first lithium-containing eluate.

Clause 30. A lithium extraction system comprising: an ion exchange softener system adapted to produce a softened aqueous lithium salt-containing solution, a lithium adsorbent system positioned downstream from the softener system and adapted to produce a lithium halide stream and a monovalent barren brine stream, and optionally, a second lithium adsorbent system positioned upstream of the ion exchange softener system.

Clause 31. The lithium extraction system of clause 30, wherein the lithium adsorbent system positioned downstream from the softener system is a first lithium adsorbent system and the system further comprises the second lithium adsorbent system that is upstream of the softener system to at least partially remove divalent cations from an aqueous lithium-salt containing solution before entering the softener system.

Clause 32. The lithium extraction system of clause 31, wherein the second lithium adsorbent system positioned upstream of the ion exchange softener system splits the aqueous lithium-salt containing solution into a low lithium purity steam and a high lithium purity stream, wherein the low lithium purity stream is provided to the ion exchange softener system and has a ratio of lithium to TDS (Li:TDS) that is lower than the high lithium purity stream.

Clause 33. The lithium extraction system of clause 32, wherein the high lithium purity stream is combined with the lithium halide stream produced by the first lithium adsorbent stream.

Clause 34. The lithium extraction system of clause 32 or 33, wherein the high lithium purity stream has a ratio of lithium to total disclosed solids (Li:TDS) that is greater than 0.08, for example greater than about 0.10, greater than about 0.11, greater than about 0.115, greater than about 0.12, greater than about 0.125, greater than about 0.13, greater than about 0.135, or greater than about 0.14, and wherein the low lithium purity stream has a ratio of lithium to TDS (Li:TDS) that is less than 0.08, for example, less than about 0.06 or less than about 0.04.

Clause 35. The lithium extraction system of any of clauses 30 to 34 wherein the system is adapted to pass the barren brine stream through a water recovery system prior to flowing the barren brine stream to the softener system.

Clause 36. The lithium extraction system of any of clauses 30-35, wherein the ion exchange softener system uses a reject or concentrate from a brackish water reverse osmosis system, a seawater reverse osmosis system, an ultra-high pressure reverse osmosis system, an osmotically assisted reverse osmosis system, an evaporation system, or a combination thereof.

Clause 37. The lithium extraction system of any of clauses 30-36, further comprising a water recovery system downstream of the lithium adsorbent system.

Clause 38. The lithium extraction system of clause 37, wherein the water recovery system uses brackish water reverse osmosis, seawater reverse osmosis, ultra-high pressure reverse osmosis, osmotically assisted reverse osmosis, evaporation, or a combination thereof.

Clause 39. The lithium extraction system of any of clauses 37 or 38, further comprising a carbonation reactor downstream of the water recovery system.

Clause 40. The lithium extraction system of any of clauses 30-39, wherein carbonization is performed with sodium carbonate or carbon dioxide insufflation.

Clause 41. The lithium extraction system of clause 40, wherein carbonation creates a lithium carbonate product and a mother liquor and the system includes a conduit for supplying the mother liquor for subsequent reprocessing.

Clause 42. The lithium extraction system of any of clauses 30-41, further comprising a conduit for contacting a softened aqueous lithium-salt containing solution with a concentrated solution of the barren brine.

Clause 43. The lithium extraction system of any of clauses 30-42, further comprising a recirculating conduit for supplying clean water by-product from a water recovery system to a lithium adsorbent system.

Clause 44. The lithium extraction system of clause 43, wherein recirculating water results in about 60% to about 99% less water usage than a corresponding method that is free of a conduit for recirculating water or recirculates less water.

Clause 45. The lithium extraction system of clause 44, wherein recirculating water results in about 90% to about 98% less water usage than a corresponding system that is free of recirculating water or recirculates less water.

1. A method of extracting lithium halide from an aqueous lithium-salt containing solution comprising monovalent and divalent cations, the method comprising:
using an ion exchange softener system to soften the aqueous lithium-salt containing solution and increase a monovalent:divalent ratio in the solution;
passing the softened aqueous lithium-salt containing solution through a lithium adsorbent system to produce a lithium halide stream and a monovalent barren brine stream;
flowing at least a portion of the barren brine stream to regenerate the ion exchange softener;
wherein a ratio of monovalent ion to divalent ion in a monovalent dominant barren brine stream is in a range of from about 100:1 to about 1,000,000:1, and
optionally passing the aqueous lithium-salt containing solution through a second lithium adsorbent system positioned upstream of the ion exchange softener system and the second lithium adsorbent system reduces a hardness of the brine to below 8,000 mg/L hardness as CaCO₃ and reduces a total dissolved solids (TDS) concentration TDS to below 40,000 mg/L TDS.

2. The method of claim 1, wherein the lithium adsorbent system is a first lithium adsorbent system and the method further comprises passing the aqueous lithium-salt containing solution through the second lithium adsorbent system upstream of the first lithium adsorbent system.

3. The method of claim 2, wherein the second lithium adsorbent system positioned upstream of the ion exchange softener system splits the aqueous lithium-salt containing solution into a low lithium purity stream and a high lithium purity stream, wherein the low lithium purity stream is provided to the ion exchange softener system and has a ratio of lithium to TDS (Li:TDS) that is lower than the high lithium purity stream.

4. The method of claim 3, wherein the high lithium purity stream is combined with the lithium halide stream produced by the first lithium adsorbent stream.

5. The method of claim 3, wherein the high lithium purity stream has a ratio of lithium to TDS (Li:TDS) that is greater than 0.08 and wherein the low lithium purity stream has a ratio of lithium to TDS (Li:TDS) that is less than 0.08.

6. The method of claim 1, further comprising preparing the aqueous lithium-salt containing solution before ion exchange softening, wherein preparing the brine comprises mechanical pretreatment, chemical pretreatment, nanofiltration, or pH adjustment, filtration, temperatures adjustment or oxidative reduction potential adjustment.

7. The method of lithium adsorbent system of claim 1, wherein the lithium halide stream comprises lithium chloride.

8. The method of claim 1, further comprising passing the barren brine stream through a water recovery system prior to flowing the barren brine stream to the softener.

9. The method of claim 8, wherein the water recovery system uses brackish water reverse osmosis, seawater reverse osmosis, ultra-high pressure reverse osmosis, osmotically assisted reverse osmosis, evaporation, or a combination thereof.

10. The method of claim 1, further comprising concentrating the lithium halide stream.

11. The method of claim 10, wherein concentrating the lithium halide stream is accomplished using a water recovery system.

12. The method of claim 11, wherein the water recovery system uses brackish water reverse osmosis, seawater reverse osmosis, ultra-high pressure reverse osmosis, osmotically assisted reverse osmosis, evaporation, or a combination thereof.

13. The method of claim 11, further comprising subjecting the concentrated lithium halide stream to carbonization to form lithium carbonate.

14. The method of claim 13, wherein carbonization is performed with sodium carbonate or caustic/carbon dioxide insufflation.

15. The method of claim 13, further comprising converting lithium carbonate to lithium hydroxide with calcium hydroxide or sodium hydroxide.

16. The method of claim 1, further comprising augmenting a monovalent cations concentration of the softened aqueous lithium-salt containing solution.

17. The method of claim 16, wherein augmenting the monovalent cations concentration of the softened aqueous lithium-salt containing solution comprises contacting the softened aqueous lithium-salt containing solution with a stream of mother liquor from carbonization.

18. The method of claim 16, wherein augmenting the monovalent cations concentration of the softened aqueous lithium-salt containing solution comprises contacting the softened aqueous lithium-salt containing solution with a concentrated solution of the barren brine.

19. The method of claim 1, wherein the barren brine is concentrated using reverse osmosis.

20. The method of claim 19, wherein the reverse osmosis uses brackish water reverse osmosis, seawater reverse osmosis, ultra-high pressure reverse osmosis, osmotically assisted reverse osmosis, evaporation, or a combination thereof.

21. The method of claim 18, wherein augmenting the monovalent cations concentration of the softened aqueous lithium-salt containing solution comprises contacting the softened aqueous lithium-salt containing solution with a monovalent halide salt recovered from the barren brine.

22. The method of claim 1, further comprising recirculating clean water by-product from an osmosis procedure to a lithium adsorbent system.

23. The method of claim 22, wherein recirculating water results in about 60% to about 99% less water usage than a corresponding method that is free of recirculating water or recirculates less water.

24. The method of claim 22, wherein recirculating water results in about 90% to about 98% less water usage than a corresponding method that is free of recirculating water or recirculates less water.

25. The method of claim 1, wherein a monovalent ion content of the lithium halide stream from the lithium adsorbent system is higher than the monovalent ion content of the lithium halide stream from the second lithium adsorbent system.

26. The method of claim 1, further comprising augmenting a softened first lithium-containing eluate with monovalent cations (low hardness TDS) before introduction to the lithium adsorbent system.

27. The method of claim 26, wherein augmenting a softened first lithium-containing eluate with monovalent cations (low hardness TDS) before introduction to a direct lithium extraction in the lithium adsorbent system comprises adding at least a portion of a mother liquor from carbonating the lithium-containing eluate to the softened first lithium-containing eluate.

28. The method of claim 26, wherein augmenting a softened first lithium-containing eluate with monovalent cations (low hardness TDS) before introduction to a direct lithium extraction in the lithium adsorbent system comprises concentrating a second barren brine with reverse osmosis and adding said concentrated second barren brine to the softened first lithium-containing eluate.

29. The method of claim 26, wherein augmenting the softened first lithium-containing eluate with monovalent cations (low hardness TDS) before introduction to a direct lithium extraction in the lithium adsorbent system comprises adding a solution of monovalent halide salts to the softened first lithium-containing eluate.

30. A lithium extraction system comprising:
an ion exchange softener system adapted to produce a softened aqueous lithium salt-containing solution,
a lithium adsorbent system positioned downstream from the softener system and adapted to produce a lithium halide stream and a monovalent barren brine stream, and
optionally, a second lithium adsorbent system positioned upstream of the ion exchange softener system.

31. The lithium extraction system of claim 30, wherein the lithium adsorbent system positioned downstream from the softener system is a first lithium adsorbent system and the system further comprises the second lithium adsorbent system that is upstream of the softener system to at least partially remove divalent cations from an aqueous lithium-salt containing solution before entering the softener system.

32. The lithium extraction system of claim 31, wherein the second lithium adsorbent system positioned upstream of the ion exchange softener system splits the aqueous lithium-salt containing solution into a low lithium purity steam and a high lithium purity stream, wherein the low lithium purity stream is provided to the ion exchange softener system and has a ratio of lithium to TDS (Li:TDS) that is lower than the high lithium purity stream.

33. The lithium extraction system of claim 32, wherein the high lithium purity stream is combined with the lithium halide stream produced by the first lithium adsorbent stream.

34. The lithium extraction system of claim 32, wherein the high lithium purity stream has a ratio of lithium to total disclosed solids (Li:TDS) that is greater than 0.08 and wherein the low lithium purity stream has a ratio of Li:TDS that is less than 0.08.

35. The lithium extraction system of claim 30, wherein the system is adapted to pass the barren brine stream through a water recovery system prior to flowing the barren brine stream to the softener system.

36. The lithium extraction system of claim 30, wherein the ion exchange softener system uses a reject or concentrate from a brackish water reverse osmosis system, a seawater reverse osmosis system, an ultra-high pressure reverse osmosis system, an osmotically assisted reverse osmosis system, an evaporation system, or a combination thereof.

37. The lithium extraction system of claim 30, further comprising a water recovery system downstream of the lithium adsorbent system.

38. The lithium extraction system of claim 37, wherein the water recovery system uses brackish water reverse osmosis, seawater reverse osmosis, ultra-high pressure reverse osmosis, osmotically assisted reverse osmosis, evaporation, or a combination thereof.

39. The lithium extraction system of claim 37, further comprising a carbonation reactor downstream of the water recovery system.

40. The lithium extraction system of claim 30, wherein carbonization is performed with sodium carbonate or carbon dioxide insufflation.

41. The lithium extraction system of claim 40, wherein carbonation creates a lithium carbonate product and a mother liquor and the system includes a conduit for supplying the mother liquor for subsequent reprocessing.

42. The lithium extraction system of claim 30, further comprising a conduit for contacting a softened aqueous lithium-salt containing solution with a concentrated solution of the barren brine.

43. The lithium extraction system of claim 30, further comprising a recirculating conduit for supplying clean water by-product from a water recovery system to a lithium adsorbent system.

44. The lithium extraction system of claim 43, wherein recirculating water results in about 60% to about 99% less water usage than a corresponding method that is free of a conduit for recirculating water or recirculates less water.

45. The lithium extraction system of claim 44, wherein recirculating water results in about 90% to about 98% less water usage than a corresponding system that is free of recirculating water or recirculates less water.
